(19) United States
(12) Patent Application Publication
(10) Pub. No.: US 2015/0059424 A1
(43) Pub. Date: Mar. 5, 2015

(54) MOTOR VEHICLE DOOR

(71) Applicant: Kiekert Aktiengesellschaft, Heiligenhaus (DE)

(72) Inventor: Rob Hunt, Davisburg, MI (US)

(73) Assignee: Kiekert Aktiengesellschaft, Heiligenhaus (DE)

(21) Appl. No.: 14/018,017

(22) Filed: Sep. 4, 2013

(51) Int. Cl. E05B 81/76; E05B 81/56; E05B 47/00; E05B 81/06; E05B 7/00; E05B 5/00

(52) U.S. Cl. CPC E05B 81/76; E05B 7/00; E05B 5/00; E05B 47/0001; E05B 81/06; E05B 81/56
USPC 70/262; 292/336.3; 70/277

(57) ABSTRACT

A motor vehicle door includes an electrically operable motor vehicle door lock (3) and a handle (5, 6) that is able to swivel around an axis (A). The handle (5, 6) is designed mechanically independent of the motor vehicle door lock (3). In addition, the handle 5, 6 has at least one associated drive (8, 9). The drive (8, 9) moves the handle (5, 6) into a gripping position or into a covering position, depending on the locked state.

### FIELD OF THE INVENTION

The invention relates to a motor vehicle door, having an electrically operable motor vehicle door lock, and having a handle that is rotatable around an axis.

### BACKGROUND

A conventional motor vehicle door construction is described for example in WO 2004079137 A2. There, a motor vehicle door lock is provided which is or may be a so-called electric lock, i.e., an electrically operable motor vehicle door lock. Such an electrically operable motor vehicle door lock, or electric lock, typically includes a locking pawl as a component of a locking mechanism including a rotary latch, and the locking pawl is withdrawn electrically from the rotary latch. As a result thereof, spring forces of one or more rubber door seals which are present ensure that the vehicle door is at least partially opened.

In WO 2004029137 A2, another handle is provided in addition at this location, which is or may be designed for example as a hinged handle. The hinged handle can be swiveled, for example, relative to a vertical axis direction of the vehicle, and thereby enables manipulation by an operator.

Furthermore, handle designs on motor vehicles are described in greater detail, for example, in DE 28 54 423 C2. In this case a control element is provided which serves to control the rotational position of an associated handle. The control element may be operated electrically or pneumatically. In this way, the handle can be swiveled between two positions. As a first portion, a first handle surface without a gripping section faces outward. A second handle portion corresponds to a second handle surface, with a gripping section that can be grasped by a user.

Furthermore, through DE 43 05 094 C1 a movable body part of a motor vehicle is known in the form of a side door or hatch, having a handle provided in the area of an exterior wall of the body. The handle can be swiveled by means of a swiveling mechanism between a gripping position and a covering position which is flush with the exterior wall.

Finally, DE 103 58 497 A1 concerns a turnable handle holder in the outside, for example, of a side door or hatch of a motor vehicle. With the aid of a turning mechanism, the handle holder can be rotated and locked between a gripping portion and a covering portion which is flush with the exterior wall of the movable body part or side door or hatch. Special U-shaped guideways are provided for turning the handle holder.

Prior art door handles are unsatisfactory in many aspects. The type-defining WO 2004079137 A2 works with a conventional opening device and with an additional emergency opening device, which is designed for example as a hinged handle which may be swiveled toward the outside. That increases the mechanical complexity of the design. Such a hinged handle further has aspects of design which need improvement. Furthermore, the present hinged and turning mechanisms for door handles are likewise of relatively complex design, and therefore difficult to implement in practice.

### SUMMARY OF THE INVENTION

The present invention remedies the above deficiencies of conventional door handle designs.

The present invention refines such a motor vehicle door so that with simple and economical construction, a functionally efficient and aesthetic door handle design is achieved.

A motor vehicle door of the present invention has a handle that is mechanically independent of the motor vehicle door lock, and has at least one accompanying drive which, depending on the state of the lock, moves the handle into a gripping position accessible to the operator or into an inaccessible covering position which is at the same time recessed as well as essentially flush with the outer surface of a door.

The present invention thus constitutes an electrically operable motor vehicle door lock or electric lock on a motor vehicle door. With the aid of such an electric lock, the associated motor vehicle door or motor vehicle door lock can be opened by motor or electric motor. The locking pawl, as a component of a locking mechanism comprising a rotary latch and locking pawl, is withdrawn from the rotary latch, which is in the closed position.

As a result, the rotary latch, for the most part with spring support, is swiveled into its open position, and releases a locking bolt which was previously captive. The associated motor vehicle door is then opened slightly due to inevitable restoring forces of a previously compressed rubber seal, or a plurality of such rubber seals.

Since the corresponding door opening or opening angle typically is not sufficient for a problem-free opening process, the handle, which is designed mechanically independent of the motor vehicle door lock, comes into play.

When the motor vehicle door lock is open, the handle is preferably in its gripping position. In contrast, the closed motor vehicle door lock corresponds in general to the covering position of the handle. When the motor vehicle door lock is open, a control unit acts on the drive associated with the handle in such a way that the handle is moved to the gripping position or is in the gripping position. When the motor vehicle door lock is closed, in contrast, the control unit ensures that the drive for the handle is actuated in such a way that the handle is in the covering position, or is moved thereto.

In exemplary embodiments, both the open position of the motor vehicle door lock and the closed position of the motor vehicle door lock are detected and queried by sensors. In the open position of the motor vehicle door lock, a corresponding open signal of the sensor ensures that the handle is moved directly to its gripping position with the aid of the drive. Conversely, the closed position of the motor vehicle door lock corresponds to a corresponding closed signal of the sensor resulting in the handle being moved to its covering position with the aid of the drive. The control unit provides the open or closed signal in each case.

The open state of the motor vehicle door lock is generally brought about by a remote control signal. Alternatively or additionally, a sensor signal present in or on the motor vehicle can be evaluated to open the door. This may involve, for example, a switch associated with an inside door handle, or in general a sensor which reflects an opening command of the operator. As a result, the motor drive of the electrically operable motor vehicle door lock or of the electric lock ensures that the locking pawl is withdrawn from the rotary latch, which is in the closed position, with the resulting consequences as described.

In contrast, the closed position of the motor vehicle door lock is brought about in most cases purely or predominantly by mechanical means. To that end, an operator closes the motor vehicle door, so that the corresponding motor vehicle door lock is moved at least into its preliminary latching position. An additional tightening drive may then provide for the motor vehicle door to be moved from its preliminary latching position to the main latching position.

When the motor vehicle door is completely closed and the corresponding motor vehicle door lock assumes its main latching position, the closed position of the motor vehicle door lock is evaluated and implemented to the effect that the closed signal of the sensor described earlier is released to the control unit. As a result of this, the control unit provides for the handle to be moved from its previously assumed gripping position to the covering position.

The drive may be connected directly to the handle or integrated into it. In general, the drive may act on the handle through an interposed gear unit. This is available in particular when the drive is connected to the handle or integrated into it.

According to one alternative, the present invention provides that the drive is placed spatially separated from the handle. In this case a transmission element is interposed between the drive and the handle, with the aid of which the drive acts on the handle. The drive may be a rotary-operating drive. Linear drives also may be employed. Depending on the design, the transmission element may be a flexible transmission element, an adjusting rod, a control wire, a cable control, or gearwheels, bevel gears, or of any suitable configuration.

For ergonomic reasons, the system will normally be set up so that the handle is designed to swivel around an axis running for the most part in the longitudinal direction of the vehicle. That means that the transition from the gripping position to the covering position and back is made in such a way that the handle is rotated into the two described positions around the axis running substantially in the longitudinal direction of the vehicle. In the gripping position, the handle is accessible to the operator. In contrast, the covering position corresponds to the handle being flush with the outer surface of the door and being essentially in an inaccessible position.

In exemplary embodiments, the handle is in at least two parts, equipped with a grip plate and a door handle. The grip plate typically has an extent or contour conforming to a door opening. As a result, the grip plate, which faces outward in the covering position of the handle, can align with the outer surface of the door, as described. In this case the outer door surface of the motor vehicle door gives way to an outer surface of the grip plate, for the most part without any gap or transition.

In contrast, a corresponding inner surface of the grip plate is normally equipped with the door handle, because the door handle spans the grip plate on the inner surface. As a result, in the covering position of the handle, the door handle faces toward the interior of the motor vehicle door, and consequently is substantially neither accessible nor visible. In the gripping position of the handle, the door handle and with it the inner surface of the grip plate-faces outward, so that an operator is able to open the motor vehicle door with the aid of the door handle.

In exemplary embodiments, the door handle runs substantially in the longitudinal direction of the vehicle. Furthermore, the grip plate is for the most part smooth-surfaced, at least with regard to its outer surface which faces outward in the covering position. For the most part, however, both the outer surface and the inner surface of the grip plate may be smooth-surfaced.

In the two swivel positions of the handle, i.e., in both the gripping position and the covering position, the motor vehicle door in the door opening is closed to keep any invading soil or water away from the door interior. To this end, the door opening may be equipped with a seal running around its rim. Alternatively or additionally, the rim of the handle or its grip plate may be equipped with an appropriate seal. An axis of the handle connects two opposite points of the door opening. In exemplary embodiments, the door opening has a more-or-less oval to elliptical shape. In this case the axis in question normally runs along the main axis, i.e., through the two focal points of the ellipse, or at least adjacent to them.

Consequently, the grip plate as such is of oval to elliptical design in plan view and predominantly flat, although within the scope of the invention curved or convex designs also may be employed. In addition, in the gripping position of the handle the grip plate may be inclined slightly obliquely in the direction of the door interior. That makes manipulation of the door handle easier for the operator because the latter normally grasps the door handle from above, and in this area encounters a significant opening slot due to the inclination of the grip plate toward the rear which makes operation easier.

As a result, a motor vehicle door is made available which is designed particularly simply and at the same time is constructed functionally. The present invention works in the first place with an electrically operable motor vehicle door lock or electric lock; that is, it expressly dispenses with mechanical operation of the motor vehicle door lock. Instead, all of the functions of the motor vehicle door lock are queried by sensors and converted to corresponding motorized setting commands. That eliminates mechanical connecting levers, for example, from an interior handle to the motor vehicle door lock.

An exterior handle in the conventional sense is not realized at all, but rather is provided by the handle which is rotatable around the axis. The design in this case is such that the handle assumes the gripping position or the covering position, depending on the state of the lock. If the motor vehicle door lock is in its open position, then the handle in the gripping position enables an operator to open the door.

To this end, the operator applies force to the door handle, which is rigidly connected to the grip plate, and can open the motor vehicle door, which is released and slightly opened by the opened motor vehicle door lock. The handle retains this gripping position until the motor vehicle door lock has reached its closed position, corresponding to the main latching position of the locking mechanism. The handle then moves to the covering position. In the covering position, the handle is for the most part flush with the outer surface of the door, because in this functional position the outer surface of the grip plate faces outward, whereas the door handle on the inner surface of the grip plate faces toward the interior of the door.

As a result, an additional protection against theft is made available, because with the handle in the covering position the door handle essentially is no longer accessible for any manipulations. In addition, this covering position of the handle is also assumed while driving, so that due to the outer surface of the grip plate being flush with the outer surface of the door the overall air resistance decreases, and consequently fuel consumption benefits are observed. The essential advantages are evident here.

### BRIEF DESCRIPTION OF THE DRAWINGS

The invention will be explained in greater detail below on the basis of drawings that depict exemplary embodiments; the figures showing the following:

FIG. 1 an exemplary motor vehicle door according to the present invention in a perspective overview, partially in sectional view, and

FIGS. 2A to 2C an exemplary door the handle in various functional positions.

### DETAILED DESCRIPTION OF THE INVENTION

The figures depict a motor vehicle door which includes an outer door surface 1 and an inner door surface 2. In the interior of the motor vehicle door, between outer door surface 1 and inner door surface 2, is a motor vehicle door lock 3 seen in the dotted line form as being internal. The motor vehicle door lock 3 interacts with its locking mechanism comprising a rotary latch and locking pawl in a known manner, using a locking bolt (not shown explicitly but is known to those skilled in the art), which is located on a motor vehicle body. The motor vehicle door lock 3 is an electrically operable motor vehicle door lock, a so-called electric lock.

Such an electrically operable motor vehicle door lock 3 or electric lock is distinguished in essence by the fact that in the closed position of the locking mechanism or the main latching position of the motor vehicle door lock 3, to open it the locking pawl is withdrawn by motor from the rotary latch. The motorized opening may be provided by a drive, or in general an actuator. The actual opening command is queried by a sensor or sensors in the associated door handles, which results in there otherwise being no mechanical connection between the motor vehicle door lock 3 and its associated door handle. Rather, the otherwise conventional mechanical connections between the door handle and the motor vehicle door lock 3 are replaced by electric conductors. To this end, a control unit 4 is provided as part of the door lock 3, which may be situated in the interior of the motor vehicle body and which, for example, receives and implements the opening command.

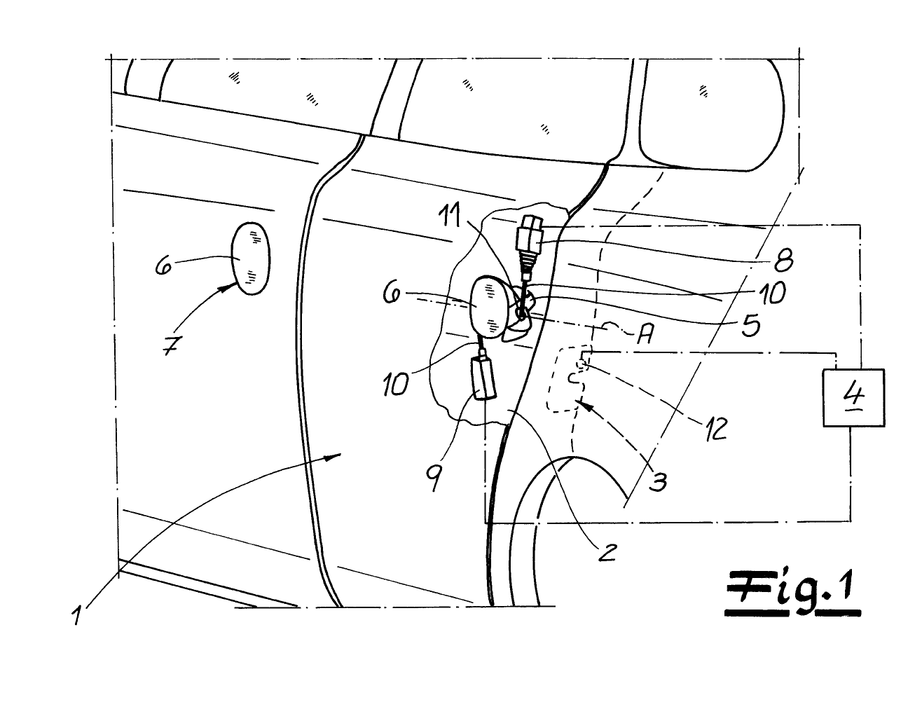

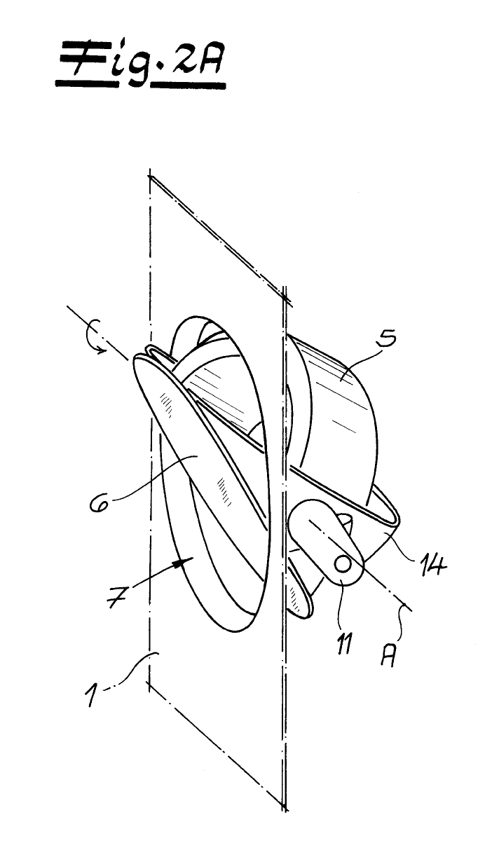

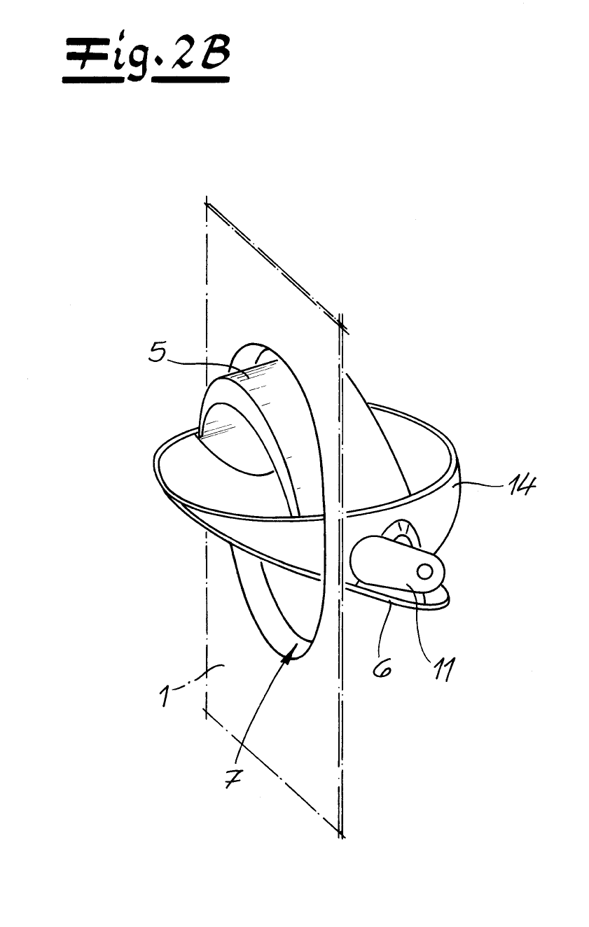

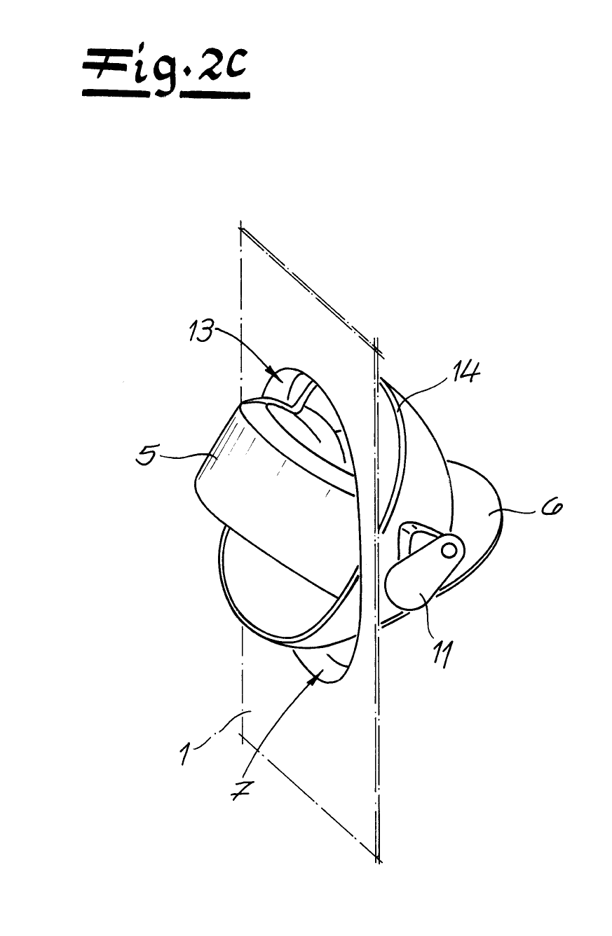

The motor vehicle door includes a handle 5, 6, which is depicted in detail in FIGS. 2A through 2C. The handle 5, 6 can be swiveled around an axis A. The handle 5, 6 is received in a door opening 7 in the outer door surface 1. In this exemplary embodiment, the door opening 7 is elliptical to oval in shape, while the axis A for the swiveling handle 5, 6 may run along the main axis of the elliptical door opening 7. In addition, the layout is such that the subject axis A for rotating the handle 5, 6 runs essentially in the longitudinal direction of the vehicle, as a comparison of FIGS. 1 and 2 makes clear.

In exemplary embodiments, the handle 5, 6 and the motor vehicle door lock 3 are mechanically independent of each other. That is, in particular there is no mechanical connection between the handle 5, 6 on the one hand and the electrically operable motor vehicle door lock 3 on the other hand. Furthermore, handle 5, 6 has at least one associated drive 8, 9. It can be seen from FIG. 1 that in the exemplary embodiment two drives 8, 9 are assigned to the handle 5, 6.

The individual drives 8, 9 are spatially separated from the handle 5, 6 in the interior of the motor vehicle door between the outer door surface 1 and the inner door surface 2. Drives 8, 9 may be linear actuators, which each operates on the handle 5, 6 by interposing a corresponding transmission element 10.

The transmission element 10 may be an adjusting rod 10, which converts linear adjusting movements of the associated drive 8, 9 to corresponding linear adjusting movements which act on one or two corresponding lugs 11 on the handle 5, 6. As soon as a drive 8, 9 or both drives 8, 9 apply the corresponding linear adjusting movements to the handle 5, 6, the adjusting rod 10 acting on the lug 11 causes the handle 5, 6 to execute corresponding swiveling motions around its axis A. In so doing, the handle 5, 6 assumes at least two stable end positions, namely the covering position depicted in FIG. 1 and the gripping position shown essentially in FIG. 2C.

In the gripping position according to FIG. 2C, the handle 5, 6 is accessible for an operator. In contrast, the covering position according to FIG. 1 corresponds to the handle 5, 6 being flush with the outer door surface 1 of the motor vehicle door. In both described positions, the handle 5, 6 may be locked. To that end, the respective drive 8, 9 or the transmission elements 10 and/or lugs 11 may be equipped with a corresponding detent. Alternatively or additionally, a locking system integrated into the drive 8, 9 also may be employed, as well as a locking system between the handle 5, 6 and the door opening 7.

The gripping position according to FIG. 2C or the covering position corresponding to FIG. 1 of the handle 5, 6 is assumed in each case depending on the state of motor vehicle door lock 3, i.e., its locked state. This is ultimately governed by the control unit 4. For this purpose, the motor vehicle door lock 3 is equipped with one or more sensors 12, which query the position of the locking mechanism in the interior of the motor vehicle door lock 3. If the locking mechanism, and therefore the motor vehicle door lock 3, is in the “closed” position, an associated closing signal of the sensor 12 to the control unit 4 causes the control unit 4 to act on the drive or the two drives 8, 9 in such a way that the handle 5, 6 assumes the covering position according to FIG. 1.

If the locking mechanism, and hence the motor vehicle door lock 3, instead assumes the “open” position, the sensor 12 emits a corresponding opening signal to the control unit 4. As a result, the control unit 4 acts on the drive or the two drives 8, 9 in such a way that the handle 5, 6 is moved to its open position, corresponding to FIG. 2C. The transition of the handle 5, 6 from the closed position according to FIG. 1 to the open position corresponding to FIG. 2C is depicted further successively in FIGS. 2A and 2B corresponding to intermediate positions, and vice versa from the open position according to FIG. 2C, through positions according to FIGS. 2B and 2A, to the closed position according to FIG. 1.

It can be seen from FIGS. 2A through 2C that the handle 5, 6 may be constructed in at least two parts. The handle 5, 6 may be made up essentially of a grip plate 6 and a door handle 5. It is clear from FIG. 1 that the grip plate 6 has an extent and contour that match the door opening 7. In addition, the grip plate 6 is equipped on its inner surface with the door handle 5. The door handle 5 actually spans the grip plate 6 on its inner surface. In contrast, the outer surface of the grip plate 6 is substantially smooth-surfaced, as can be seen from the depiction in FIG. 1. In the gripping position of the handle 5, 6 according to FIG. 2C, the inner surface of the grip plate 6 faces outward. In contrast, in the covering position according to FIG. 1 the outer surface of the grip plate 6 faces outward.

In the gripping position of handle 5, 6 corresponding to the depiction according to FIG. 2C, the grip plate 6 is situated in the door opening 7, slightly tilted obliquely toward the rear. Because of this oblique inclination of the grip plate 6, in the gripping position an opening slot 13 is available above the door handle 5. This opening slot 13 in the gripping position of the handle 5, 6 takes into account the natural hand movement of an operator when opening the door, because in this process the operator inserts his hand into the opening slot 13 from above and reaches behind the door handle 5. Since the door handle 5 is rigidly attached to the grip plate 6, and the handle 5, 6 in the corresponding grip position is necessarily locked with respect to the motor vehicle door, the motor vehicle door can be opened easily. Because the electrically operable motor vehicle door lock 3 has previously assumed its open position, the motor vehicle door has been opened slightly because of restoring forces of a rubber door seal (not shown).

For the door opening 7 to continue to be perfectly closed due to the oblique positioning of the grip plate 6 in the gripping position of the handle 5, 6, the grip plate 6 has an outer edge 14, which closes the slot that occurs between the door opening 7 and the outer door surface 1 due to the oblique position of the grip plate 6. As a result of the oblique position of the grip plate 6 with an inclination in the direction of the interior of the motor vehicle door, the outer edge 14 is dish-shaped, with decreasing dish width toward the ends and a maximum dish width in the area of the highest point of the door opening 7.

With such a configuration, the handle 5, 6 closes the door opening 7, both in the gripping position according to FIG. 2C and in the covering position according to FIG. 1, in such a way that no soil or water can enter through any remaining peripheral gap. To this end, the grip plate 6 may be additionally equipped with a peripheral seal, with any suitable seal being employed.

Although the invention has been shown and described with respect to certain preferred embodiments, it is understood that equivalents and modifications will occur to others skilled in the art upon the reading and understanding of the specification. The present invention includes all such equivalents and modifications, and is limited only by the scope of the following claims.

1. A motor vehicle door comprising:
an electrically operable motor vehicle door lock, and
a handle that is configured to swivel around an axis, wherein the handle is mechanically independent of the motor vehicle door lock and has at least one associated drive, which moves the handle into a gripping position or into a covering position, depending on the locked state of the motor vehicle door lock.

2. The motor vehicle door according to claim 1, wherein the drive is one of attached directly to or integrated with the handle.

3. The motor vehicle door according to claim 1, wherein the drive is placed spatially separated from the handle and operates on the handle by operation of a transmission element.

4. The motor vehicle door according to claim 1, wherein the axis runs substantially in a longitudinal direction of the vehicle.

5. The motor vehicle door according to claim 1, wherein the handle comprises a grip plate and a door handle.

6. The motor vehicle door according to claim 5, wherein the grip plate has a contour that is matched to a door opening.

7. The motor vehicle door according to claim 5, wherein the door handle spans the grip plate on an inner surface of the grip plate.

8. The motor vehicle door according to claim 5, wherein the door handle runs substantially in a longitudinal direction of the vehicle.

9. The motor vehicle door according to claim 5, wherein the grip plate is constructed with a smooth surface on its outer surface.

10. The motor vehicle door according to claim 1, further comprising a control unit,
wherein when the motor vehicle door lock is open the control unit acts on the drive in such a way that the handle is in the gripping position, and when the motor vehicle door lock is closed the control unit actuates the drive in such a way that the handle is in the covering position.

11. The motor vehicle door according to claim 10, further comprising a sensor that queries whether the motor vehicle door lock is open or closed, and the control unit acts on the drive handle based on a signal received from the sensor.
